(19) United States
(12) Patent Application Publication
(10) Pub. No.: US 2012/0227067 A1
(43) Pub. Date: Sep. 6, 2012

(54) METHOD AND DEVICE FOR PROVIDING COMPLEMENTARY INFORMATION

(76) Inventors: Xiao Jun Ma, Beijing (CN); Jun Xu, Beijing (CN); Guang Hua Zhou, Beijing (CN); Jun LI, Cranbury, NJ (US)

(21) Appl. No.: 13/393,850

(22) PCT Filed: Aug. 3, 2010
(86) PCT No.: PCT/EP2010/061285

§ 371 Date: May 2, 2012

(30) Foreign Application Priority Data
Sep. 15, 2009 (EP) 09305845.1

(51) Int. Cl. H04N 21/80

(52) U.S. Cl. 725/32

(57) ABSTRACT

It is provided a method for providing complementary information for principal information in a system having a first presentation device for presenting the principal information and a second presentation device for presenting the complementary information. The method comprises the steps of receiving a piece of principal information to be presented on the first presentation device; determining control information of at least one piece of complementary information associated with the received piece of principal information, wherein, the control information comprises a start time point for each piece of complementary information indicating when to present the complementary information, and sending an instruction message to instruct the second device to present the at least one piece of complementary information associated with the received piece of principal information based on the start time point contained in the control information and time information carried in the received piece of principal information.

### TECHNICAL FIELD

The present invention relates to data communication, and more particularly, relates to a method and a device for providing complementary information.

### BACKGROUND

“Two-screen solutions” or “synchronous solutions” are a form of interactive TV that enables information about a TV show to be accessed via the internet on a mobile phone, laptop, desktop PC etc. Unlike one-screen interactive TV solutions, where all of the interactivity is on the television, two-screen applications are typically done on a computer. In these cases, users do not change the content on the television, while they are accessing supplementary information about the show.

### SUMMARY

According to an aspect of present invention, it is provided a method for providing complementary information for principal information in a system having a first presentation device for presenting the principal information and a second presentation device for presenting the complementary information. The method comprises the steps of requesting for a piece of principal information to be presented on the first presentation device; determining control information of at least one piece of complementary information associated with the requested piece of principal information; and sending an instruction message to instruct the second device to present the at least one piece of complementary information associated with the requested piece of principal information based on the determined control information and the time information carried in the requested piece of principal information, wherein the instruction message comprises at least one pointer to a storage location for the at least one piece of complementary information.

According to another aspect of the present invention, it is provided a device for providing complementary information to be presented on a second presentation device while a requested piece of principal information is presented on a first presentation device. The device comprises a storage module configured to store control information of at least one piece of complementary information associated with the requested piece of principal information; and a processing module configured to send an instruction message to instruct the second presentation device to present the at least one piece of complementary information associated with the requested piece of principal information based on the stored control information and the time information carried in the requested piece of principal information, wherein, the processing module is further configured to include at least one pointer to a storage location for the at least one piece of complementary information into the instruction message.

According to the aspect of the present invention, a solution is provided to present principal information and its associated complementary information on two different presentation devices respectively. It facilitates the user to retrieve the information on the second device without affecting the content shown on the first device. Moreover, the presentation time on the second device can be programmed so as to make sure the complementary information is presented at an appropriate time.

It is to be understood that more aspects and advantages of the invention will be found in the following detailed description of the present invention.

### BRIEF DESCRIPTION OF THE DRAWINGS

The accompanying drawings, which are included to provide a further understanding of the invention and are incorporated in and constitute a part of this application, illustrate embodiments of the invention together with the description which serves to explain the principle of the invention. Therefore, the invention is not limited to the embodiments. In the drawings:

FIG. 1 is a diagram illustrating a system for providing complementary information according to an embodiment of the present invention;

FIG. 2 is a block diagram illustrating functions of the MS and the STB according to the present embodiment of the invention;

FIG. 3 is a flow chart illustrating a method for providing complementary information according to the present embodiment of the invention

FIG. 4 is a diagram illustrating another system for providing complementary information according to the present embodiment of the invention.

### DETAILED DESCRIPTION

An embodiment of the present invention will now be described in detail in conjunction with the drawings. In the following description, some detailed descriptions of known functions and configurations may be omitted for clarity and conciseness.

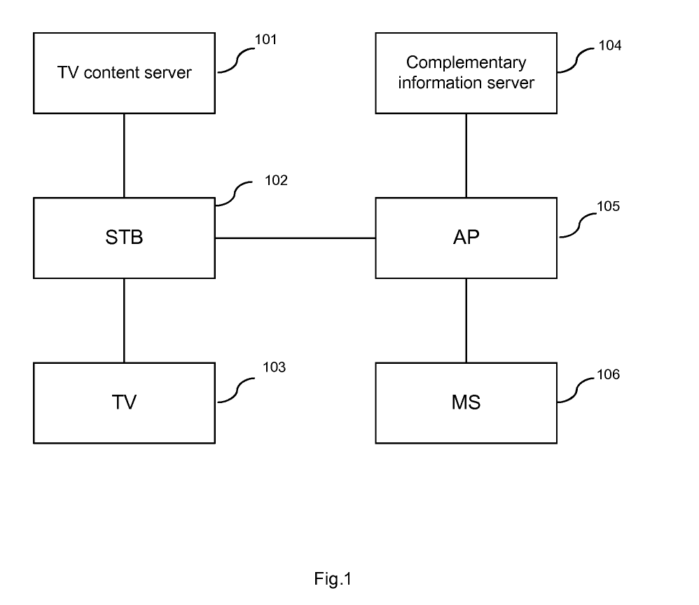

FIG. 1 is a diagram illustrating a system for providing complementary information according to the embodiment of the present invention. It should be noted this example is used to explain the invention and shall not be used to limit the scope of the invention. The exemplary system comprises a TV content server 101, a set top box (STB) 102, a TV 103, a complementary information server 104, an access point (AP) 105 and a mobile station (MS) 106. Details of their functions are as follows:

The TV Content Server 101:

it is used to provide TV programs. The programs can be provided in the form of digital signal through a cable network, or an IP network etc.

The STB 102 and the TV 103:

the STB is used to 1) receive data, i.e. TV programs, configuration files etc. from the TV content server 101; 2) display the TV programs on the TV 103; 3) send messages to and receive messages from the AP 105. As the diagram shows, the STB 102 is connected to the TV content server. Besides, it should be noted the STB 102 can also be connected to an IP network, e.g. the Internet, to fetch or receive information from a server in the IP network.

The AP 105:

it is connected to the complementary information server 104 through e.g. an IP network, to the STB 102 through e.g. a local area network (LAN), to the MS 106 through e.g. a wireless network. It shall be noted the AP 105 can be other types of access device, e.g. a router or a switch, and the connection between the access device and its associated device, e.g. computer can be a wired connection.

The MS 106:

it has a display screen for displaying the complementary information and an input function for receiving user's instructions. In addition, it can transmit the user's instructions to the STB 102. For example, when the MS 106 is configured to be capable of controlling the STB 102 and it receives an instruction input, e.g. changing to another channel, from the user, the MS 106 converts the instruction input to the corresponding instruction message that is comprehensible to the STB 102 and transmits the instruction message to the STB 102.

The Complementary Information Server 104:

it is used to provide TV programs related information, or called complementary information for TV programs. Such information may be in the form of video, audio, text, image, flash etc in terms of presentation style, and in the form of a file or a portion of a file in terms of storage. For example, the complementary information is a portion of a video file. The complementary information may be transmitted to the MS 106 through the AP 105 in the form of data stream as Internet TV does, or transmitted by using, for example, the file transfer protocol (FTP), which means that the complementary information is not displayed on the MS 106 before the completion of the complementary information transmission. A person skilled in the art will appreciate that other technologies for transmission can also be used. In addition, each piece of complementary information is associated with one or more TV programs. Below shows a configuration file for complementary information of TV programs according to the example as shown in the FIG. 1.

<?xml version=“1.0” encoding=“UTF-8” ?>
<TMSADSYS>
<ChannelInfo id=“301” name=“FTV-1” service_id=“301”
alias_name=“FTV-1”>
<ProgramInfo id=“P1” name=“Program1”>
<ComplementaryInfo id=“AD1” time_len=“10” start_point=“10”
end_point=“11”

pic_link=“http://192.168.100.14:8800/tvpalette/jiannanchun.png”
video_link=“http://192.168.100.14:8800/tvpalette/jiannanchun.avi”
more_link=“http://192.168.100.14:8800/tvpalette/jiannanchun.html” />

<ComplementaryInfo id=“ AD2” time_len=“10” start_point=“50”
end_point=“51”

pic_link=“http://192.168.100.14:8800/tvpalette/pb.png”
video_link=“http://192.168.100.14:8800/tvpalette/pb.avi”
more_link=“http://192.168.100.14:8800/tvpalette/pb.html” />

</ProgramInfo >
<ProgramInfo id=“P2” name=“Program2”>
<ComplementaryInfo id=“ AD3” time_len=“10” start_point=“20”
end_point=“21”

pic_link=“http://192.168.100.14:8800/tvpalette/sabaru-1.png”
video_link=“http://192.168.100.14:8800/tvpalette/sabaru-1.avi”
more_link=“http://192.168.100.14:8800/tvpalette/sabaru-1.html” />

</ProgramInfo>
</ChannelInfo>
<ChannelInfo id=“21” name=“FTV-2” service_id=“21”
alias_name=“FTV-2”>
<ProgramInfo id=“P2” name=“Program2”>
<ComplementaryInfo id=“ AD1” time_len=“10” start_point=“10”
end_point=“11”

pic_link=“http://192.168.100.14:8800/tvpalette/jiannanchun.png”
video_link=“http://192.168.100.14:8800/tvpalette/jiannanchun.avi”
more_link=“http://192.168.100.14:8800/tvpalette/jiannanchun.html” />

<ComplementaryInfo id=“ AD2” time_len=“10” start_point=“50”
end_point=“51”

pic_link=“http://192.168.100.14:8800/tvpalette/pb.png”
video_link=“http://192.168.100.14:8800/tvpalette/pb.avi”
more_link=“http://192.168.100.14:8800/tvpalette/pb.html” />

<ComplementaryInfo id=“ AD3” time_len=“10” start_point=“110”
end_point=“111”

pic_link=“http://192.168.100.14:8800/tvpalette/sabaru-1.png”
video_link=“http://192.168.100.14:8800/tvpalette/sabaru-1.avi”
more_link=“http://192.168.100.14:8800/tvpalette/sabaru-1.html” />

```
</ProgramInfo>
  </ChannelInfo>
  </TMSADSYS>
```

In this example, the configuration file is an extensible markup language (XML) document. It should be appreciated the configuration file may be organized in other forms, e.g. a table etc. It can be seen from the configuration file above that there are two program channels, i.e. FTV-1 and FTV-2. Each program channel is uniquely identified by the channel identifier, i.e. 301 and 21 for FTV-1 and FTV-2 respectively. In addition, each program channel has programs, i.e. FTV-1 channel has two programs of program1 and program2 while FTV-2 channel has one program of program2. Although the FTV-2 channel has a same program as the FTV-1 in this example, it should be noted it does not necessarily require different channels having same programs. The program is uniquely identified by a program identifier, i.e. P1 and P2 for the program1 and the program2 respectively. A program of a channel may be associated with one or more pieces of complementary information. For example, in the FTV-1 channel, complementary information AD1 and AD2 are associated with program1 and AD3 is associated with the program2; and in the FTV-2 channel, complementary information AD1, AD2 and AD3 are associated with program2. Further, each piece of complementary information has an identifier uniquely identifying this piece of complementary information, a link indicating where this complementary information is stored, and its control information. In this example, the complementary information has 3 links for 3 kinds of information, i.e. pic_link, video_link and more_link. The pic_link indicates a path of a picture for the complementary information, the video_link indicates a path of a video for the complementary information and the more_link indicates a path of a web page for the complementary information. The different links for the same piece of complementary information for a TV program allows different presentations on different kinds of display devices based on users' needs. For example, a cell phone may display the picture by using the pic_link, a computer may display the web page by using the more_link, or display the video by using the video_link. The control information in this example comprises parameters of time_len indicating the duration of the complementary information, start_point indicating the starting point in time relative to the start time point of a program with which the complementary information is associated and end_point indicating a point in time relative to the start time point of a program with which the complementary information is associated, wherein the notification message of the complementary information should be sent to the MS before the end_point, or otherwise, the notification message will not be sent. It should be noted a person skilled in the art may contemplate one or more links and one or more parameters of control information based on his practical needs. As in a method described below, we will use the video_link and the start_point parameter.

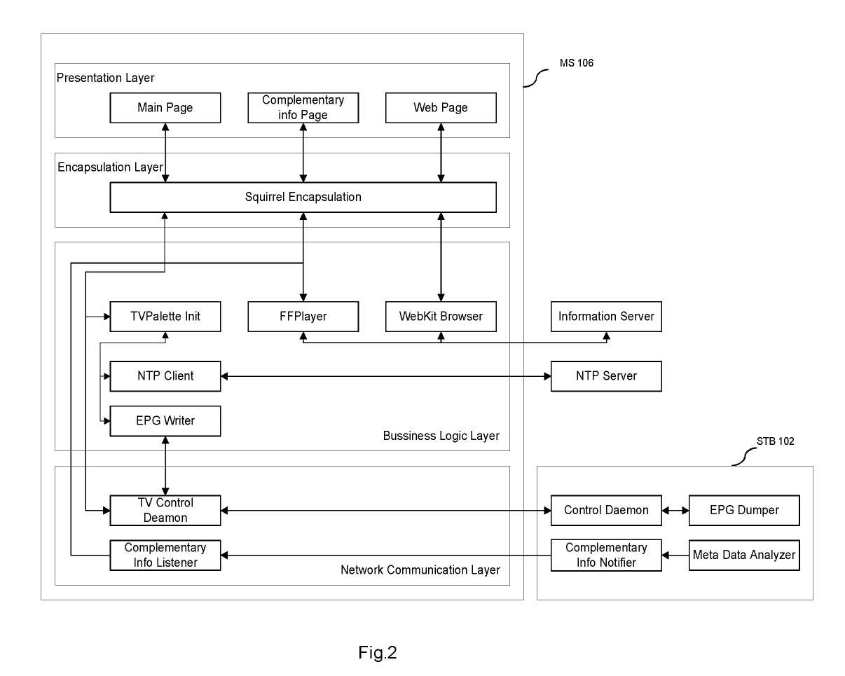

FIG. 2 is a block diagram illustrating functions of the MS 106 and the STB 102 according to the present embodiment of the invention.

The design of the MS 106 contains four layers, i.e networking communication layer, business logic layer, encapsulation layer and presentation layer. A person skilled in the art will appreciate the FIG. 2 is only for describing the invention and shall not be used to limit the scope of the invention, moreover, other designs of the MS 106 can be contemplated by a person skilled in the art after reading the following description.

The presentation layer includes modules of a main page, a complementary information page, and a web page for presentations of main pages, complementary information and web pages respectively. The presentation layer communicates with business logic layer via Squirrel script encapsulation. The Squirrel script is a programming language similar to Java script; it is primarily used as a client-side script language, implemented as an integrated component of the web browser, and allowing the development of enhanced user interfaces and dynamic websites.

In the business logic layer, when the MS starts up or restarts, the module “TVPalette Init” invokes NTP (network time protocol) client and EPG (electronic program guide) writer to get initialization of the MS before presentation of the complementary information. The NTP client communicates with a NTP server to automatically set the date and time of the MS. The EPG writer invokes TV control daemon in network communication layer to get the latest EPG information. The FFPlayer takes the instruction from the complementary Infor Listener in network communication layer and carry out the instruction accordingly. For example, when it is informed there is an instruction for presenting complementary information, it will retrieve the corresponding complementary information from the complementary information server 104 and present the complementary information, e.g. displaying visual information and/or playing aural information. The WebKit browser gets and displays relative web pages from the complementary information server or a web wide web server when the instruction for presenting a web page is received.

In the network communication layer, the TV control daemon module has the following functions: 1) requesting and receiving TV electronic program guide (EPG) from the STB; 2) sending TV control commands to the control daemon of the STB. Such control commands include channel switch, volume control, EPG fetching etc. The complementary Info listener module has the following functions: 1) listening and receiving notifications to present complementary information from the complementary info notifier of the STB if there is complementary information needed to be presented in the MS 106. In this example, the notification message from the STB contains one or more links for the complementary information and a time value indicating when to present. The FFPlayer and WebKit Browser modules use the link to retrieve the complementary information from the complementary information server. It should be noted that complementary information may be stored in a World Wide Web server and the link may be a World Wide Web link, or the complementary information may be stored in a FTP server and the link may be a FTP link.

In the STB, the control daemon and the complementary Info notifier are used to communicate with modules of network communication layer of the MS. Specifically, the control daemon module is used to 1) receive EPG request from the MS and send the EPG to the MS (the EPG is later used by the MS to control the STB, e.g. channel switch etc.). Herein the EPG is generated by the EPG dumper; 2) receive the TV control commands from the MS and execute these commands accordingly, e.g. channel switch, volume control etc. The complementary Info notifier module is used to notify the MS of presentation of the complementary information provided that the Meta data analyzer determines the complementary information is going to be presented on the MS. The meta data analyzer is used to analyze the data stream of programs and determine whether a piece of complementary information is going to be presented on the MS based on the received data stream. Specifically, the Meta data analyzer extracts the current time stamp from the data stream and compares it with the start time point of the corresponding complementary information. The details for the determination can be found in the following description. In addition, the STB can comprise a receiving module for receiving data, a storage module for storing data, e.g. the configuration file as shown above.

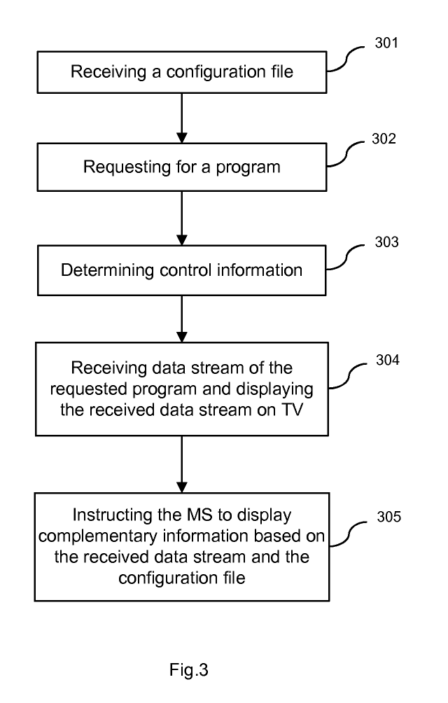

FIG. 3 is a flow chart illustrating a method for providing complementary information according to the present embodiment.

In the step 301, the STB receives a configuration file indicating the correspondence relationship between complementary information and programs of channels, control information for the complementary information and storage information for the complementary information from the TV content server 101. It should be noted the configuration file can be received from the complementary information server or other server used to store the configuration file if the STB 102 is connected to the IP based network. In this example for describing the method, the control information includes the start time point of the complementary information relative to start time points of programs, and the storage information includes the video_link. The correspondence relationship indicates which program of which program channel corresponds to which piece(s) of complementary information. In another word, the configuration file indicates which piece of complementary information relates to which program, when to display the complementary information on the MS and where to retrieve the content of the complementary information.

In the step 302, the STB requests for a program of a channel. At this step, the STB can obtain a channel identifier uniquely identifying the requested channel and program identifier uniquely identifying the requested program.

In the step 303, the STB determines control information of complementary information for the requested program based on the configuration file and the requested program. Specifically, the STB uses the channel identifier and the program identifier to query in the configuration file. Because two or more pieces of complementary information can be associated with a program of a channel, the STB needs to determine control information for all pieces of complementary information associated with the requested program. Herein, the main control information is the start time point of the complementary information.

In the step 304, the STB receives data stream of requested program and displays the received data stream on the TV.

In the step 305, the STB instructs the MS to display the complementary information associated with the requested program based on the determined control information in the step 303 and received data stream of the requested program. Specifically, the STB determines time stamp of the currently received data stream, compares the determined time stamp with the start time point of the complementary information. When the difference between the start time point and the current time stamp is below a predetermined threshold value, e.g. 30 sec, the STB sends a notification message to notify the MS of the presentation of the complementary information. The notification message includes the control information and storage information for one or more pieces of complementary information to be presented.

After receiving the notification message from the STB, the MS will also monitor the time stamp of data stream of the requested program at its side, and display the complementary information based on the control information. With respect to the transmission of the content of the complementary information, the MS can download the content of the complementary information before presentation, or receive and present the content of the complementary information in the form of data stream.

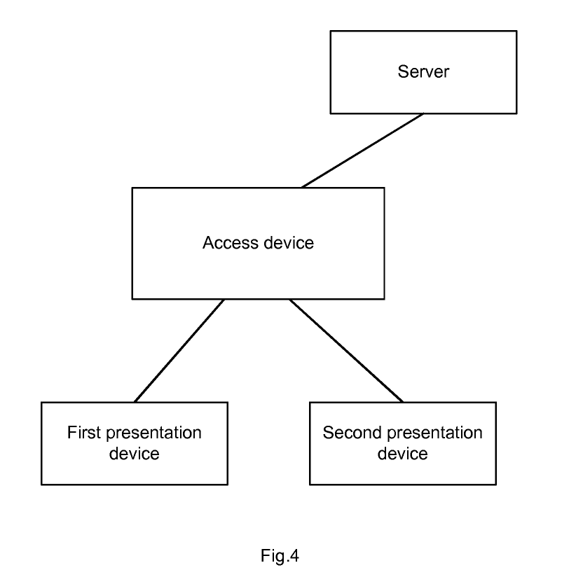

FIG. 4 is a diagram illustrating another system employing the inventive method according to the present embodiment. The system comprises an access device for performing the aforementioned method. The access device connects to one or more servers for receiving principal information, e.g. TV programs, requested video in VOD or IPTV etc., complementary information for the principal information and configuration files. A first presentation device and a second presentation device are used to present principal information and the complementary information respectively. It should be noted that the method can also be performed on the first presentation device instead the access device.

According to a variant of the present embodiment, the STB may not receive the whole configuration file, but only receive portion of the configuration file based on the requested program between the step 302 and the step 303. For example, when a user requests program2 of FTV-2, only the portion of the configuration file describing the program2 of the FTV-2 is sent to the STB. In addition, besides the transmission methods for configuration file described above, the configuration file can be transmitted either entirely or partially to the STB along with the transmission of program data stream as long as it makes sure the corresponding portion of configuration file for the requested program, e.g. including correspondence relationship, control information and storage information is transmitted to the STB before the start time point of the complementary information.

According to a variant of the present embodiment, the complementary information may be associated with a channel other than a program of a channel. In that case, the start time point of the complementary information may be related to the time reference of the channel with which the complementary information is associated with. In addition, in the environment of IPTV or video on demand (VOD), the complementary information is associated with the video files user requested, and the start time point of the complementary information may be related to the start time of the video files. Moreover, besides using the relative time, absolute time can also be used as long as the STB and the MS use the same clock reference.

According to a variant of the present embodiment, when the complementary information is associated with a channel other than a program of a channel, only the channel identifier should be determined in the step 302 and only the channel identifier is used to query in the step 303. Similarly, in case of VOD or IPTV, only a video identifier uniquely identifying the requested video is determined in the step 302 and only the video identifier is used to query in the step 303. A person skilled in the art will understand the configuration file should be modified accordingly, e.g. using the video identifier instead of the channel identifier and program identifier.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations shall fall in the scope of the invention.

1-12. (canceled)

13. A method for providing complementary information for principal information in a system having a first presentation device for presenting the principal information and a second presentation device for presenting the complementary information, wherein, comprising the steps of:
receiving a piece of principal information to be presented on the first presentation device;
determining control information of at least one piece of complementary information associated with the received piece of principal information, wherein, the control information comprises a start time point for each piece of complementary information indicating when to present the complementary information; and
sending an instruction message to instruct the second device to present the at least one piece of complementary information associated with the received piece of principal information based on the start time point contained in the control information and time information carried in the received piece of principal information.

14. The method of the claim 13, wherein the step of the determination further comprises
receiving a configuration file indicating the control information of complementary information for all pieces of principal information; and
obtaining the control information of the at least on piece of complementary information associated with the received piece of principal information by searching the received configuration file.

15. The method of the claim 13, wherein the step of the determination further comprises
receiving a message carrying the control information of the at least one piece of complementary information associated with the received piece of principal information; and
retrieving the control information from the received message.

16. The method of the claim 13, wherein, the instruction message comprises at least one pointer to a storage location for the at least one piece of complementary information.

17. The method of the claim 13, wherein the start time point is a time point relative to a time reference used by both the first presentation device and the second presentation device, or a time point relative to a time reference used by the principal information.

18. The method of the claim 13, wherein when the time point is related to a time reference used by the principal information, the step of sending further comprises
obtaining current time stamp from the received data stream of the received piece of principal information; and
if determining the difference between the start time point and the current time indicated by the current time stamp is below a predetermined threshold value, sending an instruction message to instruct the second presentation device to present a piece of complementary information corresponding to the start time point.

19. The method of claim 13, wherein the principal information comprises a video and an audio, and the complementary information comprises a text, an image, a video and an audio.

20. A device for providing complementary information for principal information, wherein, the complementary information is presented on a second presentation device while the principal information is presented on a first presentation device, the device comprising:
a storage module configured to store control information of at least one piece of complementary information associated with the received piece of principal information, wherein, the control information comprises a start time point for each piece of complementary information indicating when to present the complementary information;
a receiving module for receiving a piece of principal information; and
a processing module configured to send an instruction message to instruct the second presentation device to present the at least one piece of complementary information associated with the received piece of principal information based on the start time point contained in the stored control information and the time information carried in the received piece of principal information.

21. The device of the claim 20, wherein, the piece of principal information is carried in a data stream, and the step of sending further comprising: the processing module obtains current time stamp from the received data stream, and if determining the difference between a start time indicated by the control information and the current time stamp is below a predetermined threshold value the processing module sends the instruction message to instruct the second presentation device to present the piece of complementary information.

22. The device of the claim 20, wherein the device for providing complementary information and the first presentation device are the same device.

23. The device of the claim 20, wherein, the processing module is further configured to include at least one pointer to a storage location for the at least one piece of complementary information into the instruction message.

24. The method of the claim 13, wherein the at least one piece of complementary information associated with the received piece of principle information comprises information of different kinds allowing different presentations on different kinds of display devices.
